(19) United States
(12) Patent Application Publication
(10) Pub. No.: US 2023/0296226 A1
(43) Pub. Date: Sep. 21, 2023

(54) SNAP-IN LAMP STRUCTURE

(71) Applicant: Dongguan Huaming Lighting Technology Co., Ltd., Dongguan (CN)

(72) Inventor: WEI GAN, Chongqing (CN)

(21) Appl. No.: 17/711,984

(22) Filed: Apr. 1, 2022

(30) Foreign Application Priority Data
Mar. 18, 2022 (CN) 202220598453.9

(51) Int. Cl. F21V 19/00; F21V 23/06; F21S 4/10; F21V 17/16

(52) U.S. Cl. CPC F21V 19/0005; F21S 4/10; F21V 17/164; F21V 23/06

(57) ABSTRACT

The present invention relates to the field of lamp technologies, and discloses a snap-in lamp structure. The snap-in lamp structure includes an inner lamp holder female socket connected to a conducting wire, and a lamp bulb. An outer lamp holder female socket including a first housing and a second housing is nested outside the inner lamp holder female socket. The first housing and the second housing each are equipped with a channel. The first housing and the second housing are matched to form an opening through which the lamp bulb is inserted. The snap-in lamp structure features the following advantages: 1. The lamp holder housing can protect the lamp holder structure and prolong the service life of the lamp. 2. The lamp holder housing is easy to produce and form. 3. The production yield can be increased and the production cost reduced. 4. The production efficiency is effectively improved.

### CROSS-REFERENCE TO RELATED APPLICATIONS

The present disclosure claims priority to Chinese Patent Application No. 202220598453.9 filed on Mar. 18, 2022, the content of which is incorporated herein by reference in its entirety.

### TECHNICAL FIELD

The present invention relates to the field of lamp technologies, and in particular, to a snap-in lamp structure.

### BACKGROUND

With the popularization of electric power, lamps have been used in thousands of households. People are no longer limited to using lamps for general lighting, but also tend to use lamps to create different atmospheres. For example, at outdoor entertainment places such as a family gathering, a party or the like, lamps are used to heighten a party atmosphere, improve the interest and the artistic effect, etc.

To prolong the service life of the lamp and improve appearance coordination of the lamp, an existing lamp is generally equipped with a lamp holder housing outside a lamp holder. When a lamp holder housing is produced in the prior art, an inner lamp holder female socket is directly inserted and formed into an outer lamp holder female socket through injection molding. While being used, an inner bulb shell and an outer bulb shell of the lamp are connected into the inner lamp holder female socket and the outer lamp holder female socket respectively. As requirements on inserting and injection molding of the lamp are higher, many production process are needed. The lamp is relatively troublesome to mount or transport in use, and features high total cost. In view of this, the inventor proposes an invention.

### SUMMARY

To overcome the shortcomings in the prior art, the present invention provides a snap-in lamp structure. The snap-in lamp structure features low production cost and high efficiency.

To achieve the objective, the present invention provides a snap-in lamp structure. The snap-in lamp structure includes an inner lamp holder female socket and a lamp bulb. The inner lamp holder female socket is connected to a conducting wire, and an outer lamp holder female socket is nested outside the inner lamp holder female socket. The outer lamp holder female socket includes a first housing and a second housing clamped with the first housing. The first housing and the second housing are equipped with a channel respectively for allowing the conducting wire to pass through and fixing the conducting wire. The first housing and the second housing are matched to form an opening through which the lamp bulb is inserted.

Further, a first clamping block and a second clamping block are set on the first housing. The first clamping block and the second clamping block are symmetrically set. The first clamping block and the second clamping block are equipped with a clamping strip respectively for clamping the second housing. A first blocking position adaptive to the clamping strip is set on the second housing.

Preferably, a third clamping block is further set above the first clamping block, and a fourth clamping block is further set above the second clamping block. The third clamping block and the fourth clamping block are symmetrically set. The third clamping block and the fourth clamping block are equipped with a clamping strip respectively for clamping the second housing. A second blocking position adaptive to the clamping strip is set on the second housing.

Preferably, at least one group of positioning columns are symmetrically set on the first housing. Positioning holes adaptive to the positioning columns are set in the second housing.

Further, the first housing and the second housing are matched to form an accommodating position for accommodating the inner lamp holder female socket. A plurality of limiting strips for limiting the position of the inner lamp holder female socket are set in the accommodating position.

Preferably, a positioning ring facilitating suspending and positioning of the lamp is set outside the outer lamp holder female socket. The positioning ring is positioned on the second housing.

Further, the positioning ring is partially protruded out of the second housing. A notch for accommodating the positioning ring is correspondingly set in the first housing.

Further, an outer bulb shell is nested and connected outside the lamp bulb. The lamp bulb includes an inner bulb shell. A ring-shaped connecting part A is set on the inner bulb shell. A ring-shaped connecting part B is set on the outer bulb shell. The ring-shaped connecting part A is fixedly connected to the ring-shaped connecting part B.

Preferably, the ring-shaped connecting part A is a ring-shaped protrusion part. The ring-shaped connecting part B is a ring-shaped platform part set inside the opening end of the outer bulb shell. The ring-shaped protrusion part can abut against the ring-shaped platform part.

Preferably, an outer edge of the first housing is higher than an inner edge of the first housing. An outer edge of the second housing is lower than an inner edge of the second housing.

The beneficial effects: compared with the prior art, the present invention provides a snap-in lamp structure. The snap-in lamp structure includes an inner lamp holder female socket and a lamp bulb. The inner lamp holder female socket is connected to a conducting wire, and an outer lamp holder female socket is nested outside the inner lamp holder female socket. The outer lamp holder female socket includes a first housing and a second housing clamped with the first housing. The first housing and the second housing are equipped with a channel respectively for allowing the conducting wire to pass through and fixing the conducting. The first housing and the second housing are matched to form an opening through which the lamp bulb is inserted. The snap-in lamp structure features the following advantages: firstly, the lamp holder housing is additionally arranged on an existing lamp holder to protect the lamp holder structure and prolong the service life of the lamp. Secondly, the lamp holder housing adopts fastening connection, does not need insert molding, and is easy to produce and form. Thirdly, the fastening type lamp holder housing can increase a production yield of the lamp and can reduce the production cost. Fourthly, the structure is simple and convenient to assemble, so that production efficiency is effectively improved.

### BRIEF DESCRIPTION OF DRAWINGS

FIG. 1 is a schematic perspective view of the present invention.

FIG. 2 is a schematic diagram of the structure of an inner lamp holder female socket of the present invention.

FIG. 3 is a schematic diagram of the structure of an outer lamp holder female socket of the present invention.

FIG. 4 is a schematic diagram of the structure of the first housing of the present invention.

FIG. 5 is a schematic diagram of the structure of the second housing of the present invention.

FIG. 6 is a schematic diagram of the structure of a ring-shaped connecting part A of the present invention.

FIG. 7 is a schematic diagram of the structure of a ring-shaped connecting part B of the present invention.

FIG. 8 is a schematic diagram of the structure of the ring-shaped connecting part A in another embodiment of the present invention.

FIG. 9 is a schematic diagram of the structure of the ring-shaped connecting part b in another embodiment of the present invention.

### REFERENCE NUMERALS

1, inner lamp holder female socket; 2, lamp bulb; 21, inner bulb shell; 22, ring-shaped connecting part A; 23, connecting slot; 3, conducting wire; 4, outer lamp holder female socket; 41, first housing; 411, first clamping block; 412, second clamping block; 413, clamping strip; 414, third clamping block; 415, fourth clamping block; 416, positioning column; 417, positioning ring; 42, second housing; 421, positioning hole; 422, notch; 423, first blocking position; 424, second blocking position; 43, channel; 44, opening; 45, accommodating position; 451, limiting strip; 5, outer bulb shell; 51, ring-shaped connecting part B; 6, outer edge; and 7, inner edge.

### DETAILED DESCRIPTION

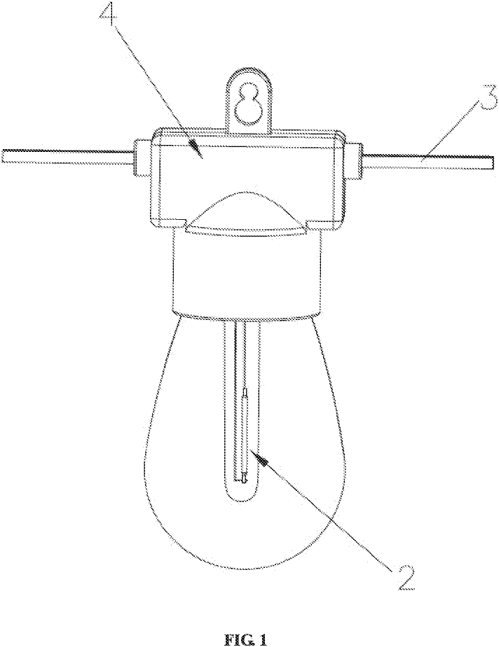

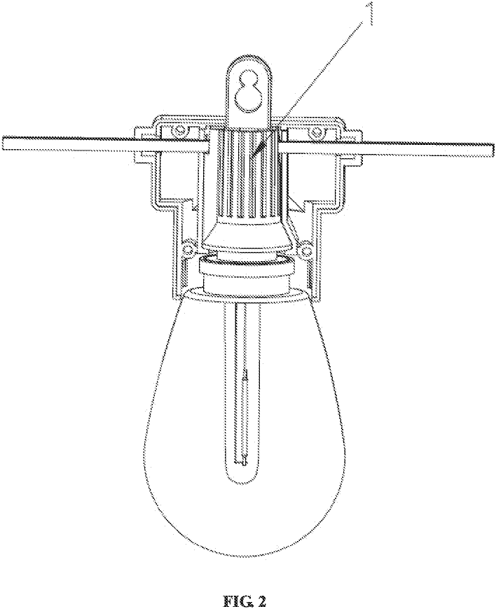

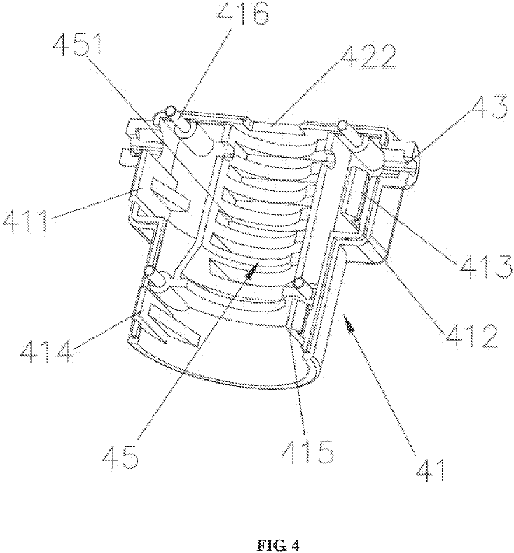

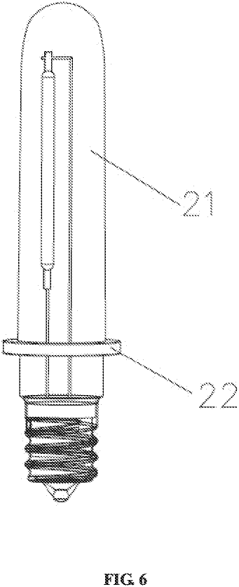

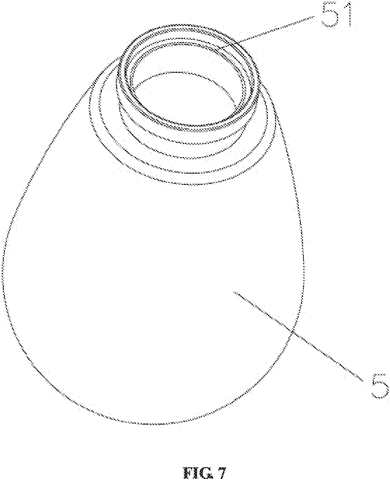

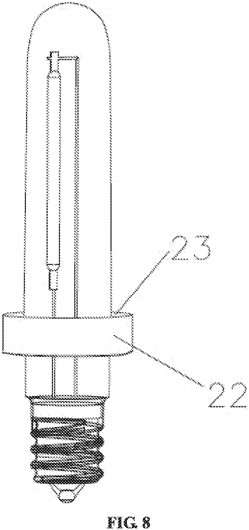

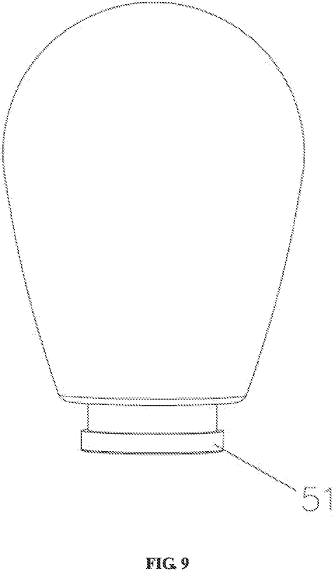

The present invention will be described in detail in conjunction with FIG. 1 to FIG. 9.

The present invention discloses a snap-in lamp structure. The snap-in lamp structure includes an inner lamp holder female socket 1 and a lamp bulb 2. The inner lamp holder female socket 1 is connected to a conducting wire 3, and an outer lamp holder female socket 4 is nested outside the inner lamp holder female socket 1. The outer lamp holder female socket 4 includes a first housing 41 and a second housing 42 clamped with the first housing 41. The first housing 41 and the second housing 42 are equipped with a channel 43 respectively for allowing the conducting wire 3 to pass through and fixing the conducting wire 3. The first housing 41 and the second housing 42 are matched to form an opening 44 through which the lamp bulb 2 is inserted. While being used, the inner lamp holder female socket 1 and the conducting wire 3 only need to put into corresponding positions of the first housing 41. Then, the second housing 42 and the first housing 41 are fastened, so that the lamp can be normally used. Manufacturing the outer lamp holder female socket 4 in a fastening manner is adopted to replace a conventional technology of directly inserting and forming the inner lamp holder female socket into the outer lamp holder female socket through injection molding. In this way, lamp holders do not need to be subjected to injection molding one by one in the manufacturing process, are convenient to subject to injection molding and automatically pressurized without considering other factors, so that the structure is simple, production efficiency is effectively improved and labor cost is reduced. In addition, a conventional lamp holder structure needs to be nested with a copper sleeve structure for connecting a lamp bulb 2, so that production cost is high. A great number of metal materials are not necessary for the improved lamp holder structure, so that production cost is greatly reduced.

In the technical solution, a first clamping block 411 and a second clamping block 412 are set on the first housing 41. The first clamping block 411 and the second clamping block 412 are symmetrically set. The first clamping block 411 and the second clamping block 412 are equipped with a clamping strip 413 respectively for clamping the second housing 42. A first blocking position 423 adaptive to the clamping strip 413 is set on the second housing 42. While being used, the clamping blocks shrink inwards under action of the second housing 42. The clamping block 413 is clamped into the first clamping position 423 of the second housing 42 mutually, so that assembly is firm and quick, and production efficiency is effectively improved.

To further improve assembly firmness of the outer lamp holder female socket 4, a third clamping block 414 is further set above the first clamping block 411 and a fourth clamping block 415 is further set above the second clamping block 412. The third clamping block 414 and the fourth clamping block 415 are symmetrically set. The third clamping block 414 and the fourth clamping block 415 are equipped with a clamping strip 413 respectively for clamping the second housing 42. A second blocking position 424 adaptive to the clamping strip 413 is set on the second housing 42. Based on the first clamping block 411 and the second clamping block 412, one group of clamping blocks are set, so that the first housing 41 and the second housing 42 are clamped more firmly to avoid the drop phenomenon and increase the yield.

To facilitate assembly, at least one group of positioning columns 416 are symmetrically set on the first housing 41. Positioning holes 421 adaptive to the positioning columns 416 are set in the second housing 42. A clamping position error easily occurs when the first housing 41 and the second housing 42 are assembled, so that the clamped lamp holder housing needs to dismount again for assembly. In this case, the clamping strips 413 on the clamping blocks easily drop and are easily damaged as a result of excessive force, so that time and labor are wasted, and production efficiency is low. Therefore, the inventor disposes a group of positioning columns 416. While being used, the positioning columns 416 only need to align to the positioning holes 421 for quickly finding a correct clamping position, so that a worker clamps with higher efficiency.

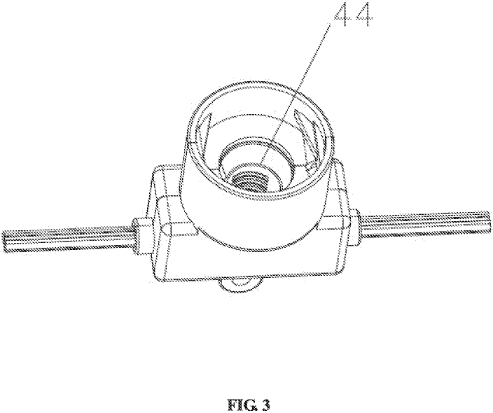

In the present invention, the first housing 41 and the second housing 42 are matched to form an accommodating position 45 for accommodating the inner lamp holder female socket 1. A plurality of limiting strips 451 for limiting the position of the inner lamp holder female socket 1 are set in the accommodating position 45. A shape of the inner lamp holder female socket 1 is as shown in FIG. 3. Compared with a shape for directly setting the accommodating position 45 into the inner lamp holder female socket 1, the ring-shaped limiting strips 451 can be set to save more raw materials. In addition, an effect of fixing the inner lamp holder female socket 1 can be well implemented.

To further improve practicability of the lamp, a positioning ring 417 facilitating suspending and positioning of the lamp is set outside the outer lamp holder female socket 4. The positioning ring 417 is positioned on the second housing 42. The lamp can be suspended and positioned, through the positioning ring 417, to many outdoor scenes such as a tree, a wall, and the like, so that a use range of the lamp is extended.

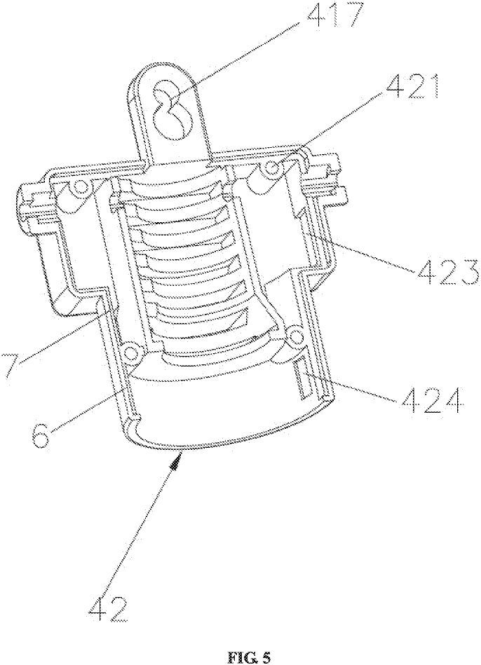

As shown in FIG. 5, the positioning ring 417 is partially protruded out of the second housing 42. A notch 422 for accommodating the positioning ring 417 is correspondingly set in the first housing 41. In this way, the position of the positioning ring 417 is always on the bottom center of the outer lamp holder female socket 4 after the first housing 41 and the second housing 42 are clamped. When suspended, the lamp does not tilt, so that the lamp enjoys a better decorative effect.

In the technical solution, an outer bulb shell 5 is nested and connected outside the lamp bulb 2. The lamp bulb 2 includes an inner bulb shell 21. A ring-shaped connecting part A22 is set on the inner bulb shell 21. A ring-shaped connecting part B51 is set on the outer bulb shell 5. The ring-shaped connecting part A22 is fixedly connected to the ring-shaped connecting part B51. The inner bulb shell 21 is directly connected to the outer bulb shell 5 through the ring-shaped connecting part A22 and the ring-shaped connecting part B51, so that the structure can be simplified, and production efficiency is greatly improved. In addition, problems such as a complex production process, high production cost and low cost in a conventional production process of a nested type lamp bulb 2 can be overcome.

As an embodiment, the ring-shaped connecting part A22 is a ring-shaped protrusion part. The ring-shaped connecting part B51 is a ring-shaped platform part set inside the opening end of the outer bulb shell 5. The ring-shaped protrusion part can abut against the ring-shaped platform part. The ring-shaped protrusion part and the ring-shaped platform part which abut against each other can directly block the ring-shaped protrusion part through the ring-shaped platform part at the opening end of the outer bulb shell 5. To be specific, the outer bulb shell 5 and the inner bulb shell 21 are directly connected by clamping, so that the effect of quickly assembling the inner bulb shell 21 and the outer bulb shell 5 is achieved. The structure is simple and assembly is quick. To further optimize the experimental scheme and improve connection stability, an ultrasonic welding manner can be further adopted for connection. The ultrasonic welding manner is convenient to use and is more stable without phenomena such as drop due to unstable connection, so that the yield is increased.

As another embodiment, a connecting slot 23 is set in the ring-shaped connecting part A22. The ring-shaped connecting part B51 is a ring-shaped protrusion part set outside the opening end of the outer bulb shell 5. The ring-shaped protrusion part is adaptive to the connecting slot 23. In this embodiment, connecting parts in the last embodiment are reversely set, so that the effect of quickly assembling the lamp bulb 2 can be achieved. The ring-shaped protrusion part and the connecting slot 23 can be also connected by clamping, ultrasonic welding or the like.

Preferably, an outer edge 6 of the first housing 41 is higher than an inner edge 7 of the first housing. An outer edge 6 of the second housing 42 is lower than an inner edge 7 of the second housing. In the technical solution, the outer edge 6 means the outer periphery of the housing, and the inner edge 7 means the inner periphery of the housing. The inner edge and the outer edge 6 which are alternatively set enables two clamped housings to have better sealing performance. In this way, impurities are not easy to enter the outer lamp holder female socket 4 through gaps.

The above content is only a preferred embodiment of the present invention, and those skilled in the art may make a change in the specific embodiment and the range of application according to the idea of the present invention. The content of the present invention should not be construed as a limit to the present invention.

What is claimed is:

1. A snap-in lamp structure, comprising an inner lamp holder female socket (1) and a lamp bulb (2), wherein the inner lamp holder female socket (1) is connected to a conducting wire (3), an outer lamp holder female socket (4) is nested outside the inner lamp holder female socket (1), the outer lamp holder female socket (4) comprises a first housing (41) and a second housing (42) clamped with the first housing (41), the first housing (41) and the second housing (42) each are equipped with a channel (43) for allowing the conducting wire (3) to pass through and fixing the conducting wire (3), and the first housing (41) and the second housing (42) are matched to form an opening (44) through which the lamp bulb (2) is inserted.

2. The snap-in lamp structure according to claim 1, wherein a first clamping block (411) and a second clamping block (412) are set on the first housing (41), the first clamping block (411) and the second clamping block (412) are symmetrically set, the first clamping block (411) and the second clamping block (412) are equipped with a clamping strip (413) respectively for clamping the second housing (42), and a first blocking position (423) adaptive to the clamping strip (413) is set on the second housing (42).

3. The snap-in lamp structure according to claim 2, wherein a third clamping block (414) is further set above the first clamping block (411), a fourth clamping block (415) is further set above the second clamping block (412), the third clamping block (414) and the fourth clamping block (415) are symmetrically set, the third clamping block (414) and the fourth clamping block (415) are equipped with a clamping strip (413) respectively for clamping the second housing (42), and a second blocking position (424) adaptive to the clamping strip (413) is set on the second housing (42).

4. The snap-in lamp structure according to claim 1, wherein at least one group of positioning columns (416) are symmetrically set on the first housing (41), and positioning holes (421) adaptive to the positioning columns (416) are set in the second housing (42).

5. The snap-in lamp structure according to claim 1, wherein the first housing (41) and the second housing (42) are matched to form an accommodating position (45) for accommodating the inner lamp holder female socket (1), and a plurality of limiting strips (451) for limiting the position of the inner lamp holder female socket (1) are set in the accommodating position (45).

6. The snap-in lamp structure according to claim 1, wherein a positioning ring (417) facilitating suspending and positioning of the lamp is set outside the lamp holder female socket (4), and the positioning ring (417) is positioned on the second housing (42).

7. The snap-in lamp structure according to claim 6, wherein the positioning ring (417) is partially protruded out of the second housing (42), and a notch (422) for accommodating the positioning ring (417) is correspondingly set in the first housing (41).

8. The snap-in lamp structure according to claim 1, wherein an outer bulb shell (5) is nested and connected outside the lamp bulb (2), the lamp bulb (2) comprises an inner bulb shell (21), a ring-shaped connecting part A (22) is set on the inner bulb shell (21), a ring-shaped connecting part B (51) is set on the outer bulb shell (5), and the ring-shaped connecting part A (22) is fixedly connected to the ring-shaped connecting part B (51).

9. The snap-in lamp structure according to claim 8, wherein the ring-shaped connecting part A (22) is a ring-shaped protrusion part, the ring-shaped connecting part B (51) is a ring-shaped platform part set inside the opening end of the outer bulb shell (5), and the ring-shaped protrusion part can abut against the ring-shaped platform part.

10. The snap-in lamp structure according to claim 1, wherein an outer edge (6) of the first housing (41) is higher than an inner edge (7) of the first housing, and an outer edge (6) of the second housing (42) is lower than an inner edge (7) of the second housing.
